(19) United States
(12) Patent Application Publication
(10) Pub. No.: US 2013/0215714 A1
(43) Pub. Date: Aug. 22, 2013

(54) METHOD, DEVICE AND NODE FOR SEABED SEISMIC ACQUISITION

(71) Applicant: Julien Meunier, Paris (FR)

(72) Inventor: Julien Meunier, Paris (FR)

(73) Assignee: CGGVERITAS SERVICES SA, Massy Cedex (FR)

(21) Appl. No.: 13/881,474

(22) PCT Filed: Dec. 22, 2011
(86) PCT No.: PCT/EP11/73826

§ 371 Date: Apr. 25, 2013

(30) Foreign Application Priority Data
Dec. 22, 2010 (FR) 1061007

(51) Int. Cl. G01V 1/20; G01V 1/18

(52) U.S. Cl. CPC G01V 1/201; G01V 1/181
USPC 367/20; 367/154

(57) ABSTRACT

The invention concerns a method for seabed seismic acquisition. According to the invention, a pair of geophones (3a, 3b) is placed on the seabed and mounted in opposite directions so that the axes of maximum sensitivity of the geophones lie substantially orthogonal to the surface of the seabed. The invention also concerns a device for seismic acquisition and a seabed seismic node.

### GENERAL TECHNICAL FIELD

The present invention relates to the field of seismic acquisition for exploration of the subsurface.

More precisely, it relates to seabed seismic acquisition.

### PRIOR ART

For land seismic surveys, vertical geophones which measure vertical movements of the ground surface are most often used. They are generally distributed over the area to be surveyed and manually “planted”. They are connected to an acquisition station via a plurality of cables. Several hundred geophones can be used at the same time.

A geophone has an axis of maximum sensitivity: when this axis is vertical, the geophone is especially sensitive to seismic compression waves which propagate up to the ground surface in vertical direction, but are generally little sensitive to shear seismic waves which propagate in horizontal direction. Sensitivity decreases the greater the distance from the direction of maximum sensitivity. Therefore, if the axis of the geophone is tilted relative to the vertical, the signals it transmits will firstly be attenuated and secondly contaminated by the shear waves projected onto its axis. Also, a conventional vertical geophone whose axis draws too far away from the vertical will cease to operate properly or even to operate. The planting of geophones is therefore a good solution to ensure the quality of acquisition.

In a marine medium, on the other hand, it is no longer possible to plant geophones to ensure their verticality. As a result, geophones are generally replaced by hydrophones which measure variations in pressure resulting from propagation of seismic waves in the aquatic medium. Hydrophones do not therefore have a priority orientation and are attached to seismic cables which can be towed at a depth of 5 to 10 m by a vessel, in which case these cables are called streamers, or they are arranged on the seabed above the area of the subsurface whose seismic image it is desired to obtain. These are called OBCs, Ocean Bottom Cables. Any bends in the cables and random orientation of the hydrophones are of no consequence.

With OBCs, when the water depth exceeds 7 to 10 metres, a phenomenon complicates the signal delivered by the hydrophone and may even make it useless. This phenomenon concerns wave reflection on the surface of the water. The solution is then to use both vertical geophones and hydrophones (see patent U.S. Pat. No. 5,935,541 on this matter) and of combining their output signals to eliminate parasitic reflections.

A solution combining geophones and hydrophones is also used when seismic receiver units which operate independently, called nodes, are placed on the seabed, these not being connected by a cable.

The problem of the verticality of geophones, at the current time, has been treated in two different manners.

A first approach consists of using gimballed geophones whose vertical orientation is obtained by means of a weight at the end of an arm which assumes a vertical direction under gravity. This is a mechanical assembly however, which is costly, fragile and hence little reliable.

It has also been proposed to use so-called “omni-tilt” geophones which operate in all directions. The drawbacks with this second solution lie in the need to use at least two geophones to reconstitute a single signal, and the fact that these geophones have a relatively high frequency (higher than 15 Hz.)

Document U.S. Pat. No. 4,078,223 describes a cable comprising modules consisting of three bipolar geophones oriented along three different axes in a plane orthogonal to the axis of the cable. By means of this relatively simple structure, there is never more than 30° between the vertical and the axis of one of the geophones. However, a deviation of 30° is sufficient to divide sensitivity by half. Also, the geophones are not as simple as conventional geophones since they are bipolar. This means that they have only one axis of maximum sensitivity, but can be positioned in either direction along this axis. A land geophone would not function if it were planted the wrong way round. Additionally, polarity inversion means are necessary for continued functioning when a cable is completely overturned.

### PRESENTATION OF THE INVENTION

The present invention sets out to allow marine acquisition on the seabed in simple, robust and low-cost manner.

For this purpose, the present invention, according to a first aspect, relates to a seabed seismic survey device comprising a cable having a longitudinal axis, a plurality of receiver casings spaced apart along the cable and each comprising two substantially planar, parallel main faces, each receiver casing being arranged along the cable so that the main faces lie parallel to the longitudinal axis of the cable, a pair of geophones positioned in each receiver casing so that their axis of maximum sensitivity lies orthogonal to the main faces, said geophones being oriented in opposite directions.

When in operation, each receiver casing rests on the seabed via one of its main faces and, irrespective of the face in contact, only one of the geophones is in a position to record seismic signals.

This only requires single-axis geophones which are low-cost and perfectly adapted to low frequencies.
According to one embodiment, the two geophones are mounted in series so that only one signal is emitted per pair of geophones;
The geophones are low frequency geophones e.g. a frequency of 10 Hz.

According to another aspect of the invention, there is provided a node intended for seabed seismic data acquisition, comprising two main faces that are substantially planar and parallel, and at least one pair of geophones housed in an enclosure positioned between said main faces and arranged so that their axes of maximum sensitivity lie parallel and orthogonal to the main faces, said geophones being oriented in opposite directions.

According to a further aspect of the invention, there is provided a method for seabed seismic data acquisition, wherein a pair of geophones is placed on the seabed mounted in opposite directions so that the axes of maximum sensitivity of the geophones lie substantially orthogonal to the surface of the seabed.

### PRESENTATION OF THE FIGURES

Other characteristics and advantages of the present invention will become apparent on reading the following description of examples of embodiment. This description is given with reference to the appended drawings in which:

FIG. 1 shows an OBC cable used for seabed seismic acquisition;

FIG. 2 is an overhead view of a section of OBC cable showing a receiver casing according to one example of embodiment;

FIG. 3 is a schematic view showing a longitudinal, vertical section of a receiver casing such as illustrated in FIG. 2;

FIG. 4 schematizes a connection which can be used in a receiver casing such as illustrated in FIG. 3;

FIG. 5 illustrates a variant of embodiment;

FIG. 6 schematizes a connection which can be used in a receiver casing such as illustrated in FIG. 5.

### DETAILED DESCRIPTION

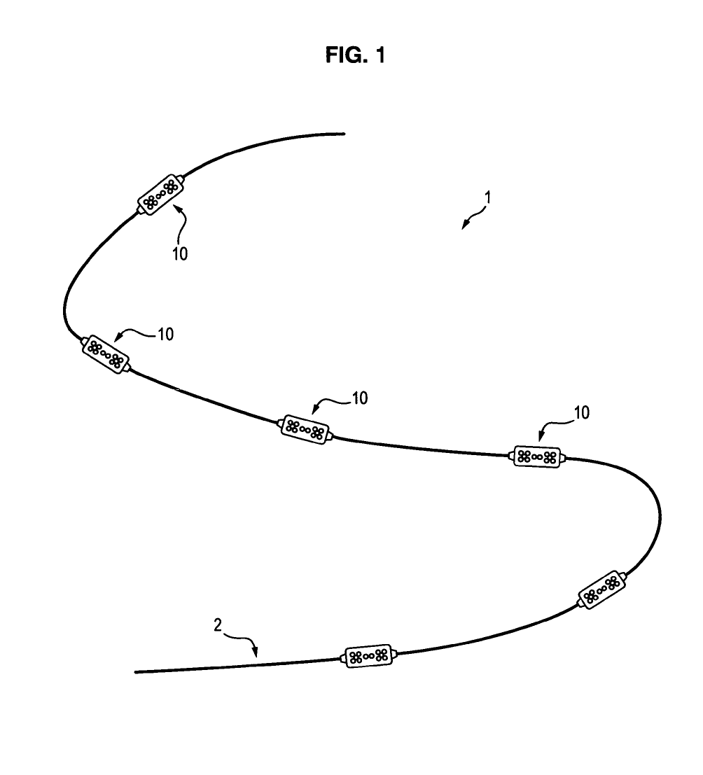

A device 1 for seabed seismic surveying, of OBC cable type, typically comprises a plurality of receiver casings arranged at regular intervals along a seismic cable 2. This architecture is illustrated in FIG. 1. Said cables can be extremely long, and notably measure up to nearly 20 km. A receiver casing 10 is usually positioned approximately every 50 m.

An OBC cable is laid on the seabed above the area of subsurface to be surveyed, by means of a manoeuvring vessel to which the end of the cable is connected.

The seismic cable 2 is used as support for the receiver casings 10, as transmission means for the data acquired by the sensors of the receiver casings 10, and as power supply cable to the seismic sensors, optionally in combination with batteries. It is designed to allow traction of the device assembly, in particular when it is retrieved on board the vessel at the end of the mission. The desired properties for cables are therefore good flexibility, high resistance to traction and high data rate. As commercial OBC cable, mention may be made of the SeaRay system marketed by Sercel.

### Receiver Casing Architecture

The cable 2 has a longitudinal axis, at least locally; if it is sufficiently long, it can be placed on the seabed forming a curve. In particular, the cable 2 is able to pass through each receiver casing 10, notably if high resistance to traction is required, or it may be in the form of sections whose ends are attached to the receiver casings 10 and aligned along the longitudinal axis.

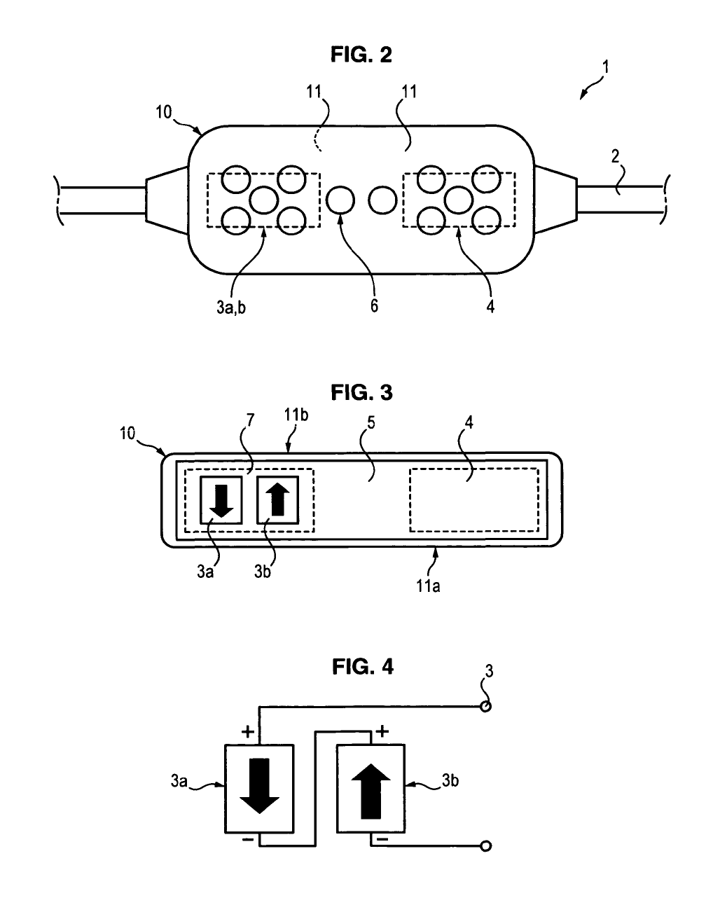

As can be seen in FIG. 2 and more precisely in FIG. 3, a receiver casing 10 has two substantially planar main faces 11a and 11b, lying parallel to one another and parallel to the longitudinal axis of the cable at the receiver casings. By main faces is meant the two faces with the largest surface area. The shape of the receiver casing 10 may be a parallelepiped, as in the illustrated embodiment. In this case, the faces 11 and 11b are rectangles. However, the receiver casing 10 is not limited to this geometry and may be in the shape of any solid having two substantially planar, parallel faces such as a cylinder (in this case, the faces 11a and 11b are discs) provided however that the solid has two main faces. One of the dimensions of the parallelepiped may appropriately be twice or more than twice smaller than the others.

With a solid having two main faces that are substantially planar and parallel, there is a very high probability that it will come to rest and remain on one of these two main faces, irrespective of the position from which it falls. Therefore, one of the main faces 11a or 11b of the receiver casing 10 is in contact with the seabed. Additionally, as explained above, the arrangement is such that the longitudinal axis of the cable 2 also lies substantially parallel to the main faces 11a and 11b. The seismic cable 2 does not therefore hamper the laying of the receiver casings 10 on the seabed, and can itself lie on the seabed. If the seabed is substantially horizontal, as is most often the case, the main faces of the receiver casings 10 are substantially horizontal.

With a parallelepiped receiver casing, the sides, i.e. the two lateral faces that are not the main faces, can suitably have a convex shape. Therefore, even in the event that a casing 10 should fall fully on one side and remain in this position, its equilibrium would be unstable and the slight motion of the cable 2 or seawater would tilt it onto one of the main faces 11a or 11b.

The casing 10, in particular its outer jacket, may be made in a rustproof material such as an aluminium-bronze. This fairly dense material protects the sensors present inside the receiver casing, and stabilizes the receiver casing 10 once is has been laid. There is little risk that it may overturn or be substantially displaced by currents. It can be provided with holes as will be explained below.

### Sensors

Each receiver casing 10 comprises at least one pair of geophones 3a and 3b, which, suitably, are conventional single-axis geophones. Appropriately, geophones are used which do not produce a signal when placed in reverse position to the normal orientation for functioning. This is obtained with geophones of sufficiently low frequency, typically a frequency of 10 Hz or less. Said geophones, capable of detecting variations in the vertical velocity of particles due to the passing of a seismic wave, are robust and low-cost. The main face of the receiver casing 10 in contact with the seabed ensures very good coupling therewith: the seismic waves are transmitted without any loss to the geophones located inside the casing. As explained previously, this face may be considered to be substantially horizontal. By aligning the axis of maximum sensitivity of the geophones 3a and 3b with a perpendicular to the main faces 11a and 11b, the geophones are therefore aligned almost perfectly with the vertical.

The geophones 3a and 3b are arranged in opposite direction to one another, as illustrated by the arrows in FIG. 3. As is conventional, the arrows indicate the direction of propagation of the wavefield to which a geophone is sensitive. In FIG. 3, the geophone 3a contains an arrow directed downwardly and geophone 3b, an arrow directed upwardly. The seismic wavefield to be recorded is an up-travelling wave which propagates from the subsurface up towards the ground surface, in this case the seabed. It is therefore geophone 3b which is oriented to produce a signal in response to the arrival of an up-travelling seismic wave. Geophone 3a, oriented in the opposite direction does not produce any signal on the arrival of the up-travelling seismic wave.

By means of this arrangement, it is indifferent whether or not the face in contact with the seabed is face 11a or face 11b. In either case, one of the geophones, and only one, is in a position to record signals representing variations in velocity due to the propagation of an upward-travelling seismic wave. The other geophone, since it is arranged in the opposite direction, lies in an inactive position and does not produce any recording reflecting the above-mentioned variations in velocity.

Different connection modes can be envisaged for the geophones. FIG. 4, as an example of embodiment, shows an assembly in series of the geophones 3a and 3b, whose output (outputs 3 connected to the cable 2) produces a single signal equivalent to the signal that would be provided by a single geophone suitably oriented for recording. This allows only one recording channel of the cable 10 to be used for the pair of geophones. With assembly in series, the only influence of the geophone in inactive position on the output signal is that of a passive electric component. It is therefore easy to offset this influence on the output signal in relation to the electric characteristics of the geophones which are known for each geophone model.

In the example of embodiment of FIGS. 2 and 3, the casing 10 comprises a hydrophone 4 as is usual. This allows the device 1 to be used at water depths of more than 7 or 10 m without being affected by reflections on the surface of the water. In FIG. 2, it is noted that the casing 10 defines an inner space 5 in which the geophones 3a, 3b and the hydrophone 4 are housed. The casing 10 is pierced with holes 6 which allow water to enter into the inner space 5 so as to place the hydrophone 4 in contact with the water. In this example of embodiment, the electric components and notably the geophones 3a and 3b are enclosed in sealed enclosures 7.

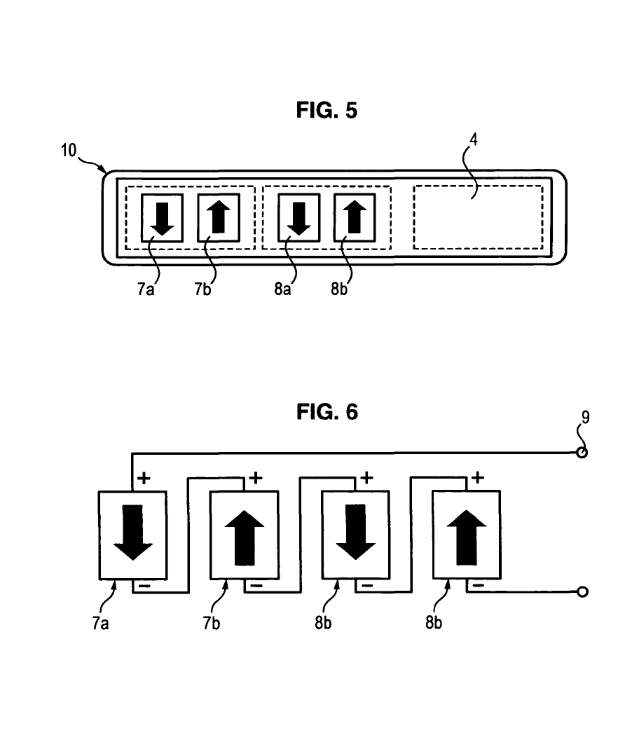

It can be envisaged to provide more than one pair of geophones within a casing 10, oriented in opposite directions, in order to increase sensitivity. Therefore FIG. 5 as an example of embodiment illustrates an embodiment in which a casing 10, in addition to a hydrophone 4, comprises two pairs of geophones 7a, 7b and 8a, 8b, the geophones of each pair being mounted in opposite directions as symbolized by the arrows: therefore the geophones 7a and 7b are mounted in opposite direction, as are the geophones 8a and 8b. In the example shown in FIG. 6, the geophones 7a, 7b and 8a, 8b are mounted in series, the outputs 9 of the assembly are connected to the cable 2.

With respect to the electric mounting mode, it is noted that the assembly in series mentioned above and illustrated in FIGS. 4 and 6 is an example of embodiment, but it is not the only solution possible. Mounting in parallel can also be considered, and if there are two pairs or more than two pairs of geophones it is possible to combine mounting in series and mounting in parallel: for example, mounting in parallel for the two geophones in opposite direction of each pair, and mounting in series of two pairs; or conversely, mounting in series for the two geophones of each pair, and mounting in parallel of two pairs.

The above-described solutions can be used in combination for optimal response to the essential needs of each situation. For example, it can be envisaged in one same cable 2 to use casings 10 containing a single pair of geophones, and other casings containing more than one pair of geophones e.g. two pairs of geophones.

As indicated in the foregoing, the invention encompasses a seismic acquisition mode other than OBC cables, namely acquisition using receiver units operating independently, called nodes. In this technique, the nodes are placed on the seabed using suitable means chosen in relation to the envisaged acquisition parameters, in particular the depth of the sea and the number of nodes to be deployed. A node conforming to the invention can be produced having characteristics similar to those of a receiver casing such as illustrated in FIGS. 2 and 3, provided the necessary adaptations are made. Therefore, a node comprises two substantially planar, parallel main surfaces and at least one pair of geophones housed in an enclosure positioned between the main faces and arranged so that their axes of maximum sensitivity lie parallel and orthogonal to the main faces, the geophones being oriented in opposite direction. It is also usual to provide for a hydrophone housed in said enclosure.

The node, unlike the receiver casing in FIGS. 2 and 3, is not connected to a cable and does not comprises connections such as the connections 2 in FIG. 2. The node also comprises a data recorder and an electric energy source such as a battery. These components are attached to the main plates so that the desired positioning of the node with one of the faces in contact with the seabed can be ensured. As mentioned above with respect to the receiver casings of the OBC cables in FIGS. 2 and 3, the plates of the nodes may have different geometries e.g. disc-shaped, circular or any other curved shape.

1. Device for seabed seismic surveying comprising:
a cable having a longitudinal axis,
a plurality of receiver casings spaced along the cable and each comprising two substantially planar, parallel main faces, each casing being arranged along the cable so that the main faces lie parallel to the longitudinal axis of the cable, and
at least one pair of geophones positioned in each casing so that their axis of maximum sensitivity lies orthogonal to the main faces,
wherein the geophones of said pair are being oriented in opposite directions.

2. The device according to claim 1, wherein the geophones are connected so that only one signal is emitted per pair of geophones.

3. The device according to claim 2, wherein the geophones are mounted in series.

4. The device according to claim 1, wherein the geophones are single-axis geophones.

5. The device according to claim 1, wherein in at least part of the casings at least a second pair of geophones oriented in opposite directions is provided.

6. The device according to claim 5, wherein all geophones positioned in one casing are mounted in series.

7. A node for seabed seismic data acquisition, comprising:
an enclosure having two substantially planar and parallel main faces; and
at least one pair of geophones housed in the enclosure and positioned between said main faces and arranged so that their axes of maximum sensitivity lie parallel to each other and orthogonal to the main faces of the enclosure, said geophones being oriented in opposite directions.

8. The node according to claim 7, wherein the geophones are mounted in series.

9. The node according to either of claim 7, further comprising at least one other pair of geophones arranged so that their axes of maximum sensitivity lie parallel to each other and orthogonal to the main faces, said geophones being oriented in opposite directions.

10. Method for seabed seismic data acquisition, the method comprising:
placing a pair of geophones on the seabed, wherein the geophones are mounted in opposite directions, so that axes of maximum sensitivity of the geophones lie substantially orthogonal to the surface of the seabed.

11. The method according to claim 10, wherein the geophones are connected so that only one signal is emitted per pair of geophones.

12. The node according to claim 7, wherein the geophones are connected so that only one signal is emitted per pair of geophones.

13. The node according to claim 7, wherein the geophones are single-axis geophones.

14. The node according to claim 7, further comprising:
at least a second pair of geophones oriented in opposite directions.

15. The node according to claim 14, wherein all geophones are mounted in series.

16. The method of claim 10, further comprising:
mounting the geophones in series.

17. The method of claim 10, wherein the geophones are single-axis geophones.

18. The method of claim 10, wherein in at least part of the casings at least a second pair of geophones oriented in opposite directions is provided.

19. The method of claim 18, wherein all geophones positioned in one casing are mounted in series.

20. The method of claim 10, further comprising:
deploying a cable having a longitudinal axis on the ocean bottom, the cable having a receiver casing and the casing comprising two substantially planar, parallel main faces, the casing being arranged along the cable so that the main faces lie parallel to the longitudinal axis of the cable and the casing houses the pair of geophones.
